(19) United States
(12) Patent Application Publication
(10) Pub. No.: US 2026/0094602 A1
(43) Pub. Date: Apr. 2, 2026

(54) AUTOMATED CUSTOMIZED INCOMING CALL ANNOUNCEMENTS

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); PHILIP WEINSTEIN, Apex, NC (US)

(21) Appl. No.: 18/899,022

(22) Filed: Sep. 27, 2024

(51) Int. Cl. G10L 15/18; G06F 3/16; G10L 21/003

(52) U.S. Cl. CPC G10L 15/1822; G06F 3/16; G10L 21/003

(57) ABSTRACT

A method provides techniques for creating automated customized incoming call announcements. The method includes obtaining audio voice data for a voice conversation from a call between a user of the communication device and a second person. The audio voice data is then parsed to identify a salutation issued by one of the user and the second person in the audio voice data. An audible incoming call announcement is generated to associate with the second person, based at least in part on the salutation. In response to receiving an incoming call originating from a device of the second user, outputting the audible incoming call announcement in lieu of a default call announcement.

### BACKGROUND

### 1. Technical Field

The present disclosure generally relates to electronic communication devices, and more specifically to electronic devices that output incoming call announcements.

### 2. Description of the Related Art

Most smartphones today come with a wide range of basic functions that go beyond just making and receiving calls. Modern smartphones are sophisticated electronic communication devices that can perform media playback, perform navigation functions, serve as a camera for acquiring video and still images, and much more. Yet, the basic telephony functions for making and receiving voice calls are still important functions of these devices.

Ringtones for telephones play a crucial role in modern communication. A main purpose of a ringtone is to serve as an incoming call announcement to audibly alert the user of an incoming call. Without an audible alert, users may miss important calls, especially when the users are not actively looking at their phones. Additionally, the availability of different ringtones allows users to express their individuality and preferences through selections of specific music or sounds as a ringtone.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement automated customized incoming call announcements, according to one or more embodiments;

FIG. 2A is an example phone conversation, including a salutation, according to one or more embodiments;

FIG. 2B illustrates an automated customized incoming call announcement, based on the conversation indicated in FIG. 2A, according to one or more embodiments;

FIG. 3A is another example phone conversation, including a first salutation and a second salutation, according to one or more embodiments;

FIG. 3B illustrates an automated customized incoming call announcement, based on the second salutation in the conversation indicated in FIG. 3A, according to one or more embodiments;

FIG. 4 illustrates a combined sequential audio sample that includes a salutation, according to one or more embodiments;

FIG. 5 illustrates a combined mixed audio sample that includes a salutation, according to one or more embodiments;

FIG. 6 shows an exemplary user interface that may be rendered on an electronic device for automatic ringtone configuration, according to one or more embodiments;

FIG. 7 depicts a flowchart of a computer-implemented method for automated customized incoming call announcements, according to one or more embodiments; and

FIG. 8 depicts a flowchart of a computer-implemented method for automated customized incoming call announcements based on a user-issued salutation, according to one or more embodiments.

### DETAILED DESCRIPTION

According to aspects of the present disclosure, an electronic device, a method, and a computer program product provide techniques for creating automated customized incoming call announcements. Customizable incoming call announcements (or ringtones) offer several benefits that can enhance the user experience with a mobile telephone. Custom ringtones enable a user to express his/her unique taste and personality. The source of the ringtone can be a song, sound effect, or even a recording that reflects a user's interests and style. Furthermore, by assigning specific ringtones to different contacts, a user can instantly identify who is calling without looking at his/her phone. This can be particularly useful for distinguishing between personal and work calls. Additionally, custom ringtones can streamline a user's communication by allowing the user to quickly identify important calls and messages, enabling the user to respond more efficiently.

Creating custom ringtones can be fun, but the process does come with some challenges and inconveniences. For example, creating custom ringtones often requires some basic technical skills to edit audio files and convert them into the correct format. This can involve using audio editing software such as Audacity or GarageBand, which has a learning curve. Even when the user has proficiency in audio editing, the process of finding the right audio clip, editing the clip to the desired length, and converting the clip to the correct format can be time-consuming. Additionally, transferring an edited audio file to a smartphone and placing the file in the correct folder can be a bit cumbersome, especially if the user is not familiar with file management on the device.

The disclosed embodiments simplify the task of creating customized incoming call announcements. According to one or more embodiments, salutations exchanged during a telephone conversation between two users can be automatically extracted and presented to the user as an audio sample that the user can associate as a sound for the device to produce when an incoming call from a particular contact is detected. Additionally, the sounds can be mixed with and/or appended to music samples to create custom incoming call announcements that can include the caller's voice or the voice of the call recipient. Accordingly, disclosed embodiments can greatly simplify the potentially cumbersome task of creating a customized call announcement (or ringtone) for a specific caller.

One or more embodiments can include a communication device including: at least one output device; a memory having stored thereon an automatic call announcement (ACA) module; and at least one processor communicatively coupled to the memory, the at least one processor executing program code of the ACA module, and is configured to cause the communication device to: obtain audio voice data for a voice conversation from a call between a user of the communication device and a second person; parse the audio voice data to identify a salutation issued by at least one of the user and the second person in the audio voice data; generate an audible incoming call announcement, in part based on the salutation; and in response to receiving an incoming call originating from a device of the second person, output the audible incoming call announcement in lieu of a default call announcement.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

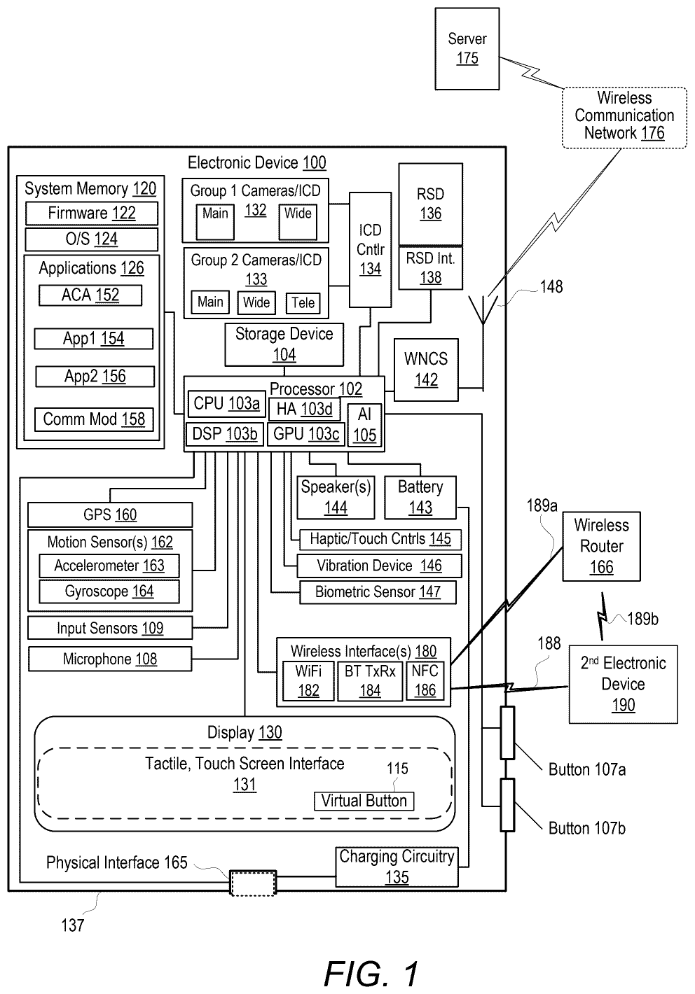

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to generate incoming call announcements based on salutations detected in voice conversations, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c, and certain aspects of device communication via wireless networks are performed by DSP 103b, with support from CPU 103a.

For simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, automatic call announcement (ACA) module 152, other applications (apps) indicated as App1 154 and App2 156, and communication module 158. Additional applications may also be present. Each module and/or application provides program instructions/code that are processed by processor 102 to cause processor 102 and/or other components of electronic device 100 to perform specific operations, as described herein. For example, automatic call announcement (ACA) module 152 can include program instructions for implementing features of the disclosed embodiments. ACA module 152 can include instructions that cause or configure processor 102 to obtain audio voice data for a voice conversation from a call between a user of the communication device and a second person, parse the audio voice data to identify a salutation issued by one or both of the user and the second person in the audio voice data, generate an audible incoming call announcement, in part based on the salutation, and in response to receiving an incoming call originating from a device of the second person, output the audible incoming call announcement in lieu of a default call announcement. Descriptive names assigned to these executable modules add no functionality and are provided solely to identify the underlying features performed by processing the different modules.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger or stylus on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. Other embodiments provide for multiple integrated displays within electronic device 100 and references to integrated display 130 are assumed to refer to one or all of these multiple integrated displays.

Electronic device 100 can further include microphone 108, one or more output devices such as speakers 144, and one or more input buttons, indicated as 107a and 107b. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. While two buttons are shown in FIG. 1, other embodiments may have more or fewer input buttons. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. In one or more embodiments, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera), which provides facial recognition for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or direct powering of electronic device 100.

Electronic device 100 further includes wireless network communication subsystem (WNCS) 142, which can represent one or more front end devices (not shown) that are each coupled to one or more antennas 148. In one or more embodiments, WNCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, such as second electronic device 190. via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WNCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, such as second electronic device 190, which can be similarly connected to wireless communication network 176. In one or more embodiments, various functions that are being performed on communications device 100 can be supported using or completed via/on server 175. Second electronic device 190 can be a communication device, such as a smartphone. In one or more embodiments, an automated customized incoming call announcement can be created based on data obtained from second electronic device 190.

In one or more embodiments, electronic device 100 can communicate wirelessly with external wireless devices, such as a WiFi router 166 or second electronic device 190, via one or more of short-range wireless interface(s) 180. Electronic device 100 can wirelessly communicate with second electronic device 190 via communication signal 188 (communicating between wireless interface(s) 180 and second electronic device 190). Communication signal 189a and communication signal 189b provide a communication path from electronic device 100 to second electronic device 190. In one or more embodiments, signals 188 and/or signals 189a may be transmitted by short range communication device(s) within wireless interface(s) 180. Wireless interface(s) 180 can include short-range wireless communication adapters/transceivers, such as wireless fidelity (Wi-Fi) transceiver 182 for Wi-Fi connectivity, Bluetooth transceiver 184, and near field communication (NFC) transceiver 186. In one or more embodiments, electronic device 100 can receive Internet or Wi-Fi based calls, text messages, multimedia messages, and other notifications via wireless interface(s) 180. In one or more embodiments, WNCS 142 with antenna(s) 148 and wireless interface(s) 180 collectively provide/represent the wireless communications subsystem of electronic device 100.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

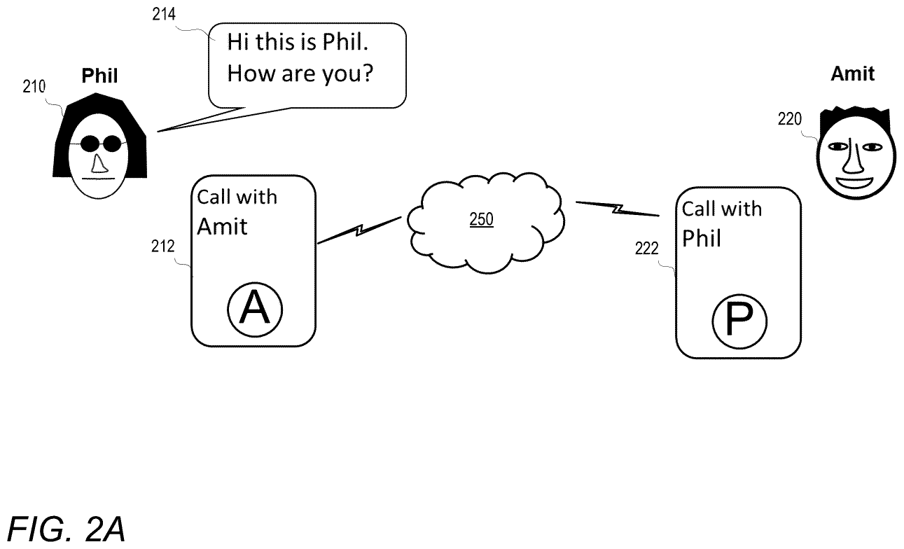

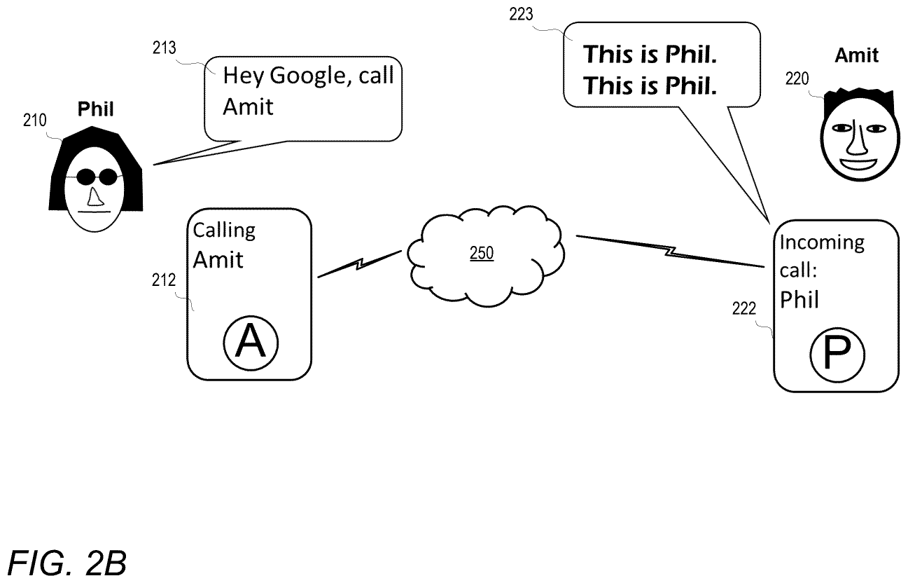

FIG. 2A illustrates an example phone conversation that includes a salutation, according to one or more embodiments. As indicated in FIG. 2A, a calling party (Phil), indicated at 210 has used his communication device 212, to place a call to a recipient user (Amit), indicated at 220 via communication network 250. The recipient user receives and answers the incoming call on his communication device 222. When the call connects, the calling user 210 utters an introductory phrase, indicated at 214. The introductory phrase includes the words: “Hi this is Phil. How are you? ” For purposes of the illustration, recipient communication device 222 is representative of electronic device 100.

In one or more embodiments, the communication device 222 associated with the recipient user 220 extracts a salutation from the introductory phrase. In one or more embodiments, the extraction of the salutation from the introductory phrase can be accomplished using machine-learning and/or artificial intelligence techniques such as natural language processing. In the presented embodiment, communication device 222 extracts the salutation “This is Phil” from the introductory phrase indicated at 214 in FIG. 2A. The extracted salutation can be stored as an audio file in the memory/storage of communication device 222. Additionally, an association between the audio file and the calling party can be established within a database and/or data table that is stored on, or accessible to, communication device 222. The association enables the audio file to be used as an incoming call announcement for the calling party.

FIG. 2B illustrates an automated customized incoming call announcement, generated based on the conversation indicated in FIG. 2A, according to one or more embodiments. As shown in FIG. 2B, the calling user (Phil) 210 subsequently initiates (following the initial call and generation of the call announcement) a voice call via voice command indicated at 213. While a voice command is shown as the means by which the call in the example of FIG. 2B is initiated, other techniques, such as keypad dialing, selecting a name of a contact via a user interface, and/or other suitable techniques may be used to initiate the voice call. During the subsequent receipt of the incoming call from calling communication device 212 by recipient communication device 222, the call announcement comprised of the extracted salutation “This is Phil” can be output as an incoming call announcement from communication device 222, as indicated at 223. The utterance can be output as was originally recorded, in the calling user's voice (e.g., ‘Phil's voice,’ in this example). In this way, when the recipient user (Amit) gets a call from the calling user (Phil), the recipient user communication device 222 outputs a customized incoming call announcement that uses the caller's voice. Alternatively, in some embodiments, the call announcement can be computer-generated and/or can include additional/different phrases in addition to the utterance captured from the calling user.

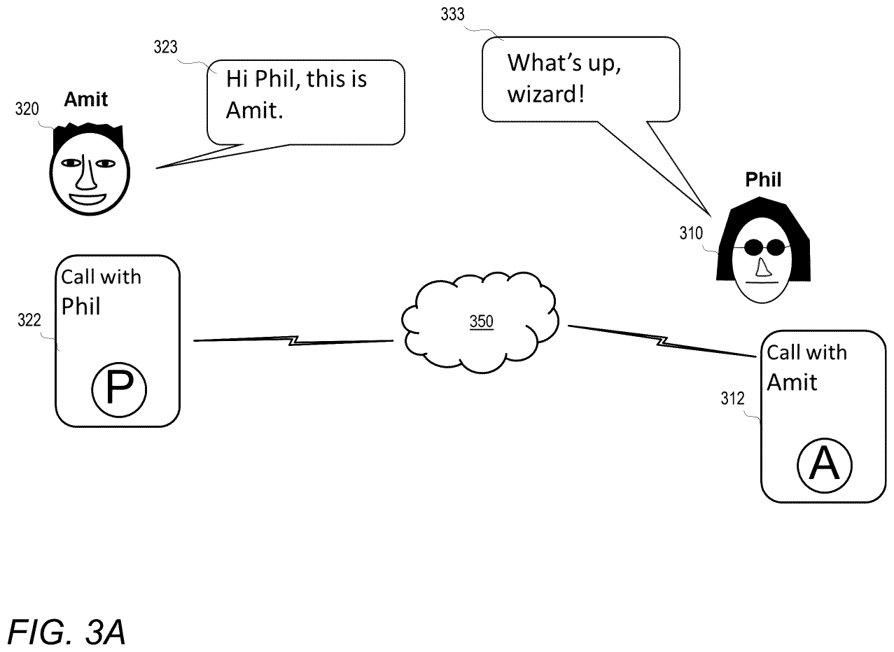

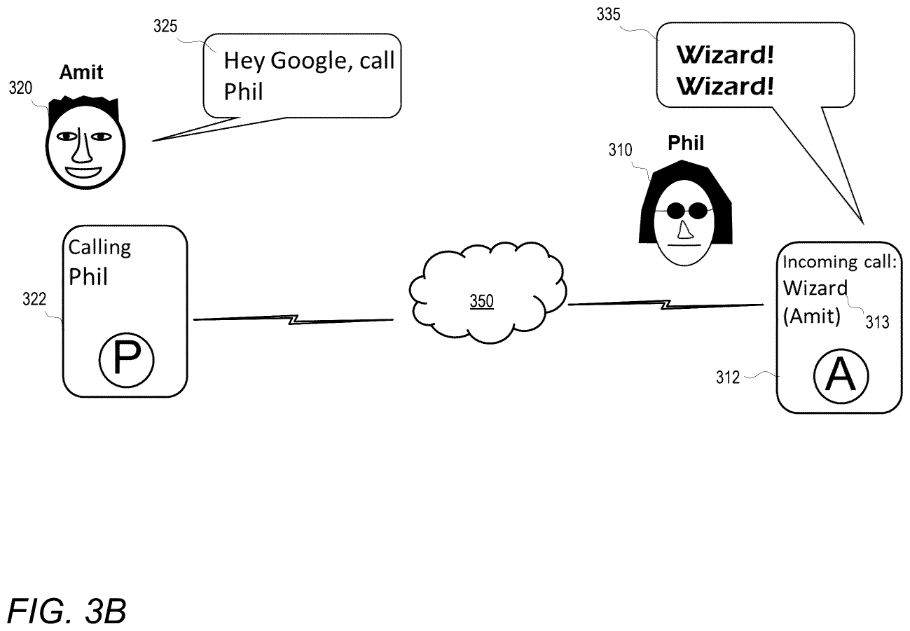

FIG. 3A is another example phone conversation, including a first salutation from the calling party and a second salutation from the recipient party, according to one or more embodiments. In one or more embodiments, the second salutation can be a response to the first salutation. Accordingly, the second salutation can be a user-issued salutation from a recipient of an incoming call. As indicated in FIG. 3A, a calling party (Amit), indicated at 320 has used his communication device 322, to place a call via communication network 350 to a recipient party (Phil), indicated at 310. The recipient party 310 receives and answers the incoming call on his communication device 312. When the call connects, the calling party 320 utters an introductory phrase, indicated at 323. The introductory phrase includes the words: “Hi Phil. This is Amit.” In response, the recipient party 310 utters a second introductory phrase, indicated at 333. The second introductory phrase includes the words “What's up wizard!”

In one or more embodiments, the communication device 312 associated with the recipient party (user) 310 extracts a salutation from the second introductory phrase. The second introductory phrase can include a salutation that includes an alias (nickname). In the presented embodiments, the communication device 312 extracts the salutation “Wizard” from the second introductory phrase indicated at 333 in FIG. 3A. The extracted salutation can be stored as an audio file in the memory/storage of the communication device 312. Additionally, an association between the audio file and the calling user can be established within a database and/or data table stored on, or accessible to, communication device 312. The association enables the audio file to be used as an incoming call announcement for the calling party. The extracted salutation “Wizard” can be stored as an audio file and associated with a particular contact for use during a subsequent incoming call from communication device 322 to communication device 312. In this example, the extracted salutation is an alias. That is, the word “Wizard” serves as an alias for user “Amit” indicated at 320. In one or more embodiments, the determination of an alias may be performed via machine-learning based natural language processing (NLP) techniques. While FIG. 3A shows the user-issued salutation as occurring after the calling party salutation, in one or more embodiments, the user-issued salutation may occur before a salutation from the calling party.

FIG. 3B illustrates an automated customized incoming call announcement, based on the conversation indicated in FIG. 3A, according to one or more embodiments. The calling party (user) 320 initiates a voice call to recipient party 310 by voice utterance indicated at 325, causing an incoming call to be initiated from communication device 322 of calling party and received by communication device 312 of receiving party. The incoming call is announced via the stored customized incoming call announcement generated from the previous exchange of salutations, i.e., the alias “Wizard”. In the example of FIG. 3B, the customized incoming call announcement is created based on data provided in/parsed from the second introductory phrase, which was uttered by the recipient. Additionally, a text representation 313 of the alias can be rendered on the display of the communication device 312.

One or more embodiments can include determining an alias for the second person, in part based on the salutation issued by the user in the audio voice data, and appending the alias to the contact record corresponding to the second person. The alias can then be output as an incoming call announcement in response to a subsequent incoming call from a communication device associated with the contact as indicated at 335 in FIG. 3B. In one or more embodiments, the utterance/alias can be output as obtained, in the recipient user's voice (e.g., ‘Phil's voice,’ in this example). In this way, when the recipient user (Phil) gets a call from the calling user (Amit), communication device 312 of the recipient user outputs a customized incoming call announcement that uses the recipient's voice and includes an alias that the recipient user uses to refer to the calling user. The extraction of the salutation from the second introductory phrase can be accomplished using machine-learning and/or artificial intelligence techniques such as natural language processing. In one or more embodiments, an extracted salutation from one source (application) may be used for a custom incoming call announcement for another application. In one or more embodiments, the automatic call announcement (ACA) module 152 provides extracted salutations to one or more applications within the system memory 120 via an application programing interface (API), JSON file, XML file, and/or other suitable techniques. As an example, an extracted salutation from a voice call can be used for an incoming call announcement for an incoming Discord call, incoming WhatsApp call, and/or other communication applications.

It is appreciated that the example of FIG. 3A can also lead to generation of a salutation at the recipient party's communication device for calls received from the calling party's communication device, similar to what is presented by the examples of FIGS. 2A and 2B. Additionally, in some embodiments, the name/nickname/alias presented by the calling party to reference the recipient party can be applied to the contact for the recipient party. Subsequent calls originating from the original recipient party would then include a customized announcement that includes the name/nickname/alias that the original calling party uses to refer to the original recipient party who is now originating the call. For example, a husband who calls his wife and refers to her as “My Love”, would receive calls from his wife with the audio announcement of “My Love”and displayed incoming call label of “My Love”.

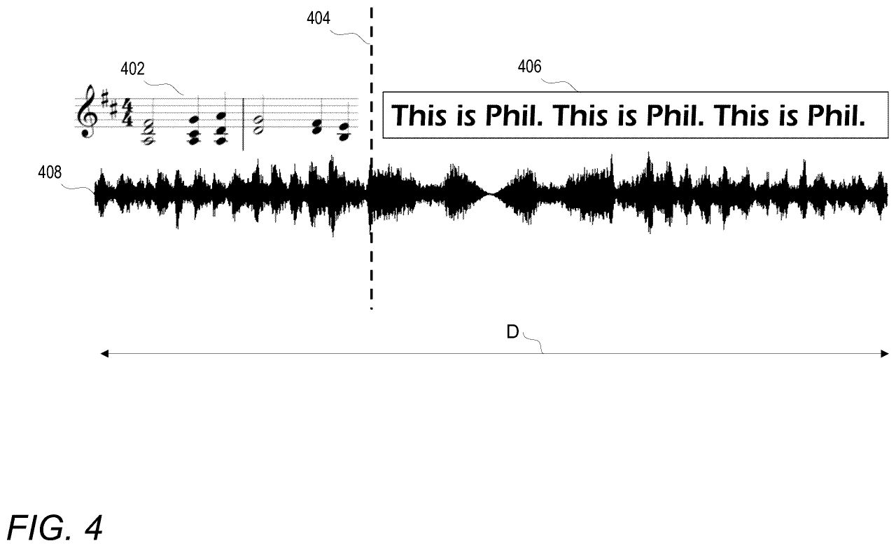

FIG. 4 illustrates a combined sequential audio sample that includes a salutation, according to one or more embodiments. The example in FIG. 4 shows a music sample 402 that plays up until a temporal split point indicated at 404, followed by a voice announcement indicated at 406. A combined sequential audio sample 408 is stored in a file in memory (120 of FIG. 1) of the communication device 100. In the example of FIG. 4, the music sample 402 is played first, followed by the voice announcement 406, which is recorded from a previous salutation. However, in one or more embodiments, the voice announcement 406 can be first, followed by the music sample 402. In one or more embodiments, the audio sample 408 is output repeatedly (i.e., ‘looped’), for the duration of time that the incoming call announcement is output from the communication device. As an example, if the duration D is 8 seconds, and the duration of the incoming call announcement is 24 seconds, then the audio sample 408 is output three times. One or more embodiments can include combining the salutation with an audio data sample to create a combined sequential audio sample, and associating the combined sequential audio sample with a contact record corresponding to the second person.

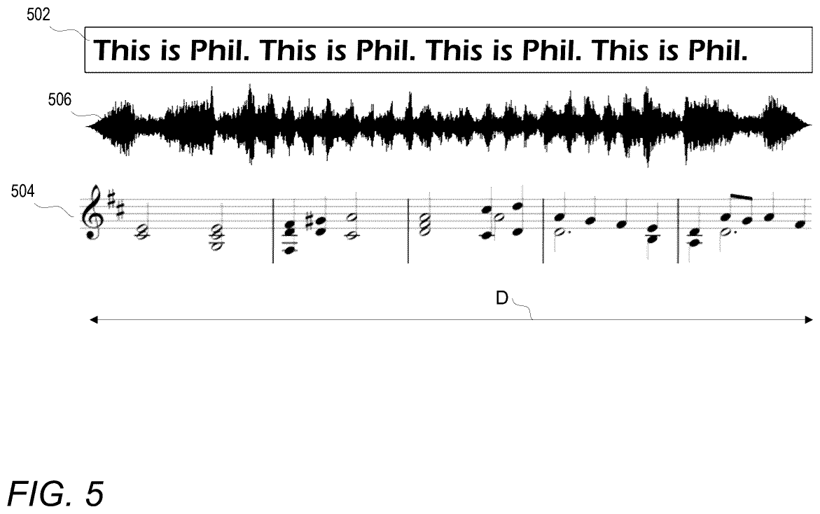

FIG. 5 illustrates a combined mixed audio sample that includes a salutation, according to one or more embodiments. The example in FIG. 5 shows a music sample 504 that is mixed with a voice sample 502. A combined mixed audio sample 506 is stored in a file in memory (120 of FIG. 1) of the communication device. In the example of FIG. 5, the music sample 504 is mixed for the duration of, and plays concurrently with, the voice sample 502. In one or more embodiments, the mixing level of the music sample 504 and voice sample 502 is such that the gain of the voice sample is greater than the gain of the music sample 504, such that the voice can be clearly heard over the music. In one or more embodiments, the audio sample 506 is output repeatedly (i.e., ‘looped’), for the duration that the incoming call announcement is output from the communication device. As an example, if the duration D is 8 seconds, and the duration of the incoming call announcement is 24 seconds, then the audio sample 506 is output three times. One or more embodiments can include mixing the salutation with an audio data sample to create a combined audio sample, and associating the combined audio sample with a contact record corresponding to the second person.

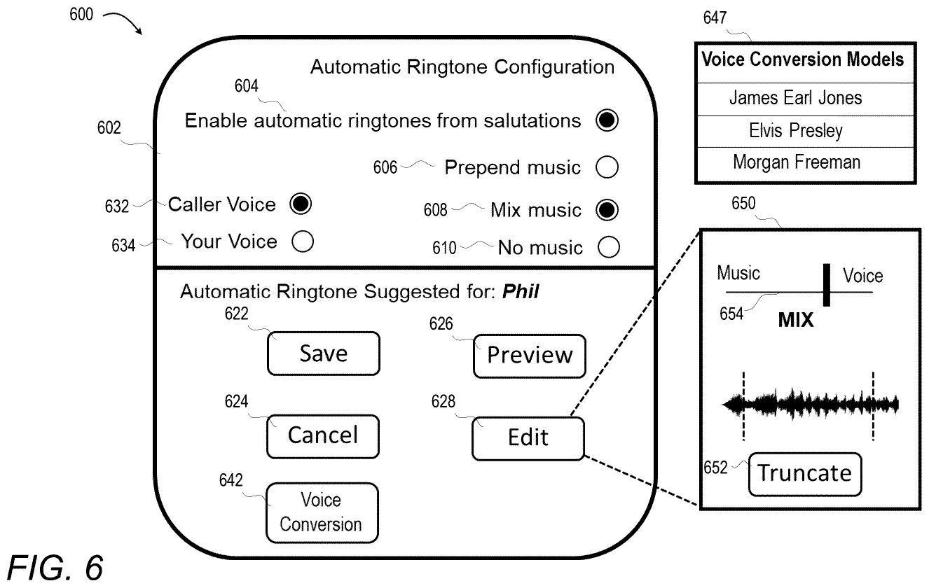

FIG. 6 shows an exemplary user interface 602 that may be rendered on display 600 of an electronic device to provide automatic ringtone configuration, according to one or more embodiments. In one or more embodiments, the user interface shown in FIG. 6 may be rendered on a display 600 of a device such as device 100 of FIG. 1. In one or more embodiments, the user interface 602 can include an option 604 to enable automatic generation of ringtones from salutations. The option 604 allows a user to “opt in” to use the feature for automating the process of creating ringtones from salutations. The user interface 602 can further include an option 606 to prepend music, such as illustrated in FIG. 4. The user interface 602 can further include an option 608 to intermix music with the voice sample, such as illustrated in FIG. 5. The user interface 602 can further include an option 610 to have no music included in the incoming call announcement. As can be seen in FIG. 6, option 608 is the currently selected option. The user interface 602 can further include an option 632 to use the voice of the caller for the incoming call announcement (ringtone). The user interface 602 can further include an option 634 to use the voice of the recipient user for the incoming call announcement (ringtone). One or more embodiments can include identifying a salutation issued by the user in the audio voice data, storing the salutation as a user-issued salutation audio data sample, displaying a user option to use the user-issued salutation audio data sample as a call announcement for calls originating from a second electronic device associated with the second person, and in response to receiving an affirmative acknowledgement for the user option, associating the user-issued salutation audio data sample with a contact record corresponding to the second person (calling party). As can be seen in FIG. 6, option 632 is the currently selected option.

The user interface 602 can further include options for previewing, editing, and/or saving an audio sample that is recommended to be used as a custom incoming call announcement. One or more embodiments can include storing a history of audio data for multiple voice conversations between the second person and the user, and determining the salutation based on detecting a phrase in an opening period of a predetermined number of voice calls. The determined salutation can be used as a recommended custom incoming call announcement. A preview button 626, when invoked, causes the communication device to output a preview of the incoming call announcement (ringtone). If the user wishes to save the incoming call announcement, the user can invoke the save button 622. In one or more embodiments, the save button 622, when invoked, causes the communication device to store the audio file that includes the incoming call announcement in persistent storage on the device, and associate the audio file with a contact in a contact database located in memory of the device, so that the next time an incoming call from the contact occurs, the associated audio file is output as the incoming call announcement. If the user wishes to discard the incoming call announcement, the user can invoke the cancel button 624. In one or more embodiments, the cancel button 624, when invoked, causes the communication device to discard the audio file that includes the incoming call announcement, in which case, the audio file is deleted from and/or not stored in persistent storage on the device.

An edit button 628, when invoked, causes the communication device to render a user interface 650 to enable editing of the audio file. The edit functionality can include a truncate button 652, that when invoked by a user, enables truncating the audio file, removing one or more portions of the audio file, and/or a mix control 654 for adjusting a mix balance between audio and voice for a combined mixed audio sample such as shown in FIG. 5. Additional features can include capabilities for adjusting a temporal split point for a combined sequential audio sample such as shown in FIG. 4, and/or other relevant editing options.

One or more embodiments may provide an option for voice conversion. In the presented embodiments, a voice conversion button 642, when invoked, causes the communication device to present submenu 647 to enable selection of a voice model to use for voice conversion. In one or more embodiments, the extracted salutation undergoes voice conversion based on machine-learning and/or AI techniques. In one or more embodiments, the voice conversion includes extracting features from the input audio signal, such as pitch, timbre, and phonetic content. In one or more embodiments, a voice conversion model, based on deep learning techniques, is trained to map the features of the source voice to the target voice. This model learns to transform the input audio signal to sound like the target speaker's voice while preserving the linguistic content. The transformed features are then used to synthesize the output audio signal. The result includes generating the waveform that matches the target speaker's voice characteristics. In one or more embodiments, the synthesized voice may undergo additional processing to improve its naturalness and quality. This can include adjustments to the pitch, tone, and other aspects of the voice to make it sound more realistic. In this way, disclosed embodiments can enable voice conversion to change the vocal properties of an incoming call announcement to make it sound like it is another person's voice. The other person's voice can be a celebrity with a recognizable voice, such as, for example, Elvis Presley or James Earl Jones. In one or more embodiments, the available voices conversion options can include male and/or female voice conversion options.

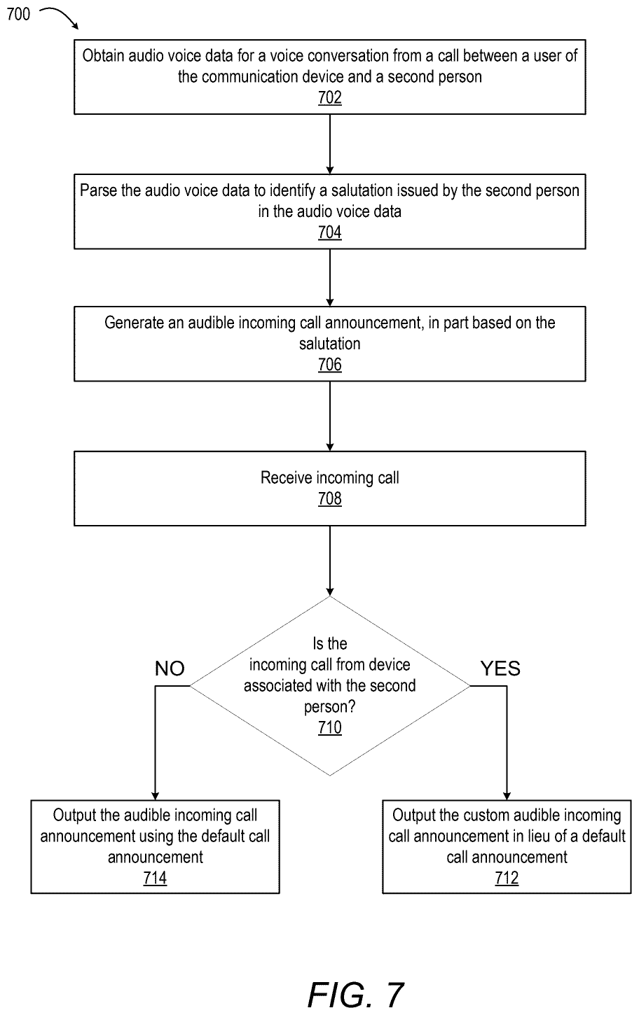

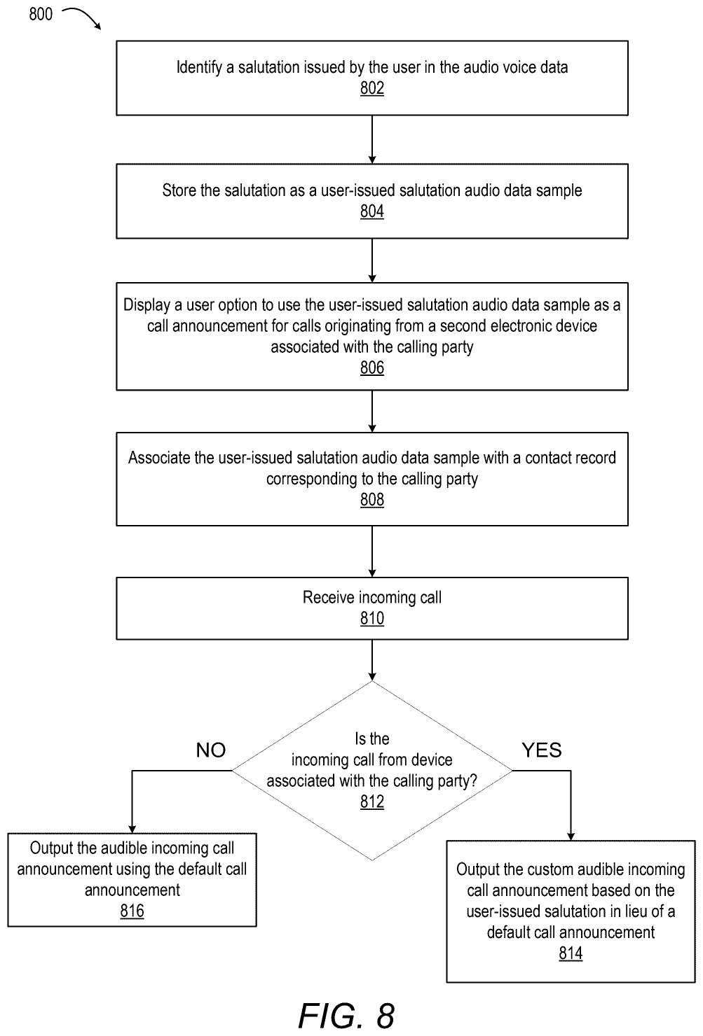

Referring now to the flowcharts presented by FIG. 7-FIG. 8, the descriptions of the methods in by FIG. 7-FIG. 8 are provided with general reference to the specific components and features illustrated within the preceding FIG. 1-6. Specific components referenced in the methods of by FIG. 7-FIG. 8 may be identical or similar to components of the same name used in describing preceding FIG. 1-6. In one or more embodiments, processor 102 (FIG. 1) can be configured to cause electronic device 100 (FIG. 1) to provide the described functionality of the methods of FIG. 7-FIG. 8 by executing program code for one or more modules or applications provided within system memory 120 of electronic device 100, including automatic call announcement (ACA) module 152.

FIG. 7 depicts a flowchart of a computer-implemented method for creating automated customized incoming call announcements, according to one or more embodiments. The method 700 starts at block 702, where audio voice data for a voice conversation from a call between a user of the communication device and a second person is obtained. The audio voice data can be in a PCM (Pulse code modulated) format, compressed format, such as MP3 (MPEG Layer 3), WAV format, or other/suitable format. The audio voice data can be in a little-endian or big-endian format. The method 700 continues to block 704, where parsing is performed on/within the audio voice data to identify a salutation issued by at least one of the user and the second person in the audio voice data. The parsing can include performing a speech-to-text process on the audio voice data.

One or more embodiments may utilize automatic speech recognition (ASR) and/or natural language processing (NLP) to identify and transcribe spoken words into text. In one or more embodiments, the ASR component converts the audio signal into a sequence of words. This involves acoustic modeling, which maps audio data to phonetic units, and language modeling, which predicts the sequence of words. The process can further include dividing the audio signal into smaller segments and identifying the phonemes within these segments. The phonemes are converted to phonetic symbols, which can include letter combinations used to create text from the spoken speech in the audio data. Once the speech is converted to text, the NLP component analyzes the text to understand its structure and meaning. The analysis can include tokenization, which involves breaking down the text into individual words or tokens. The analysis can further include Part-of-Speech tagging which identifies the grammatical parts of speech (e.g., nouns, verbs, adjectives) for each token. The analysis can further include performing Named Entity Recognition (NER), which involves identifying and classifying entities in the text (e.g., names, dates, locations).

The method 700 continues with generating an audible incoming call announcement, in part based on the salutation at block 706. In one or more embodiments, the aforementioned analysis can include performing pattern recognition utilizing predefined patterns or machine learning models to recognize common salutations. For example, phrases like “Hello,” “Hi,” “Good morning,” “Greetings,” etc., are identified as salutations based on their context and position in the sentence. Names from the NER process can be included when following a salutation, along with any intervening words. As an example, a salutation of “Hello” followed by the phrase “This is Phil” can be included together as an audio voice sample for use as an incoming call announcement.

In one or more embodiments, a database or other suitable data structure contains an association between a given audio file and a particular contact in a contact database. The association can be based on a name, username, telephone number, and/or other suitable criteria. At block 708, an incoming call is received. At block 710, a check is made to determine if the incoming call is from a device associated with the second person. The check can include comparing an incoming telephone number with a contact database stored within the electronic device that is receiving the incoming call. If, at block 710, it is determined that, based on the criteria is received, the incoming call is associated with a custom incoming call announcement, the method 700 continues to block 712, where the audio file is output as the incoming call indication, such as depicted in FIG. 2B. If, at block 710, it is determined that, based on the criteria is received, the incoming call is not associated with a custom incoming call announcement, the method 700 continues to block 714, where the default call announcement is output.

FIG. 8 depicts a flowchart of a computer-implemented method 800 for automated customized incoming call announcements based on a user-issued salutation, according to one or more embodiments. The method 800 starts with identifying a salutation issued by the user in the audio voice data at block 802. In one or more embodiments, the user can be a recipient of an incoming call from a calling party. In one or more embodiments, the salutation is based on an utterance by a user that occurs at or near the beginning of an incoming call. An example of such an utterance is shown at 333 in FIG. 3A. The salutation can be extracted utilizing automatic speech recognition (ASR) and/or natural language processing (NLP) as previously described. The method 800 continues with storing the salutation as a user-issued salutation audio data sample at block 804. The user-issued salutation can be stored in memory of the communication device in a format such as PCM, WAV, MP3, or other suitable format as previously described. The method 800 continues with displaying a user option to use the user-issued salutation audio data sample as a call announcement for calls originating from a second electronic device associated with the calling party at block 806. In one or more embodiments, the functionality of block 806 can include functionality provided by option 634 in FIG. 6. The method 800 continues with associating the user-issued salutation audio data sample with a contact record corresponding to the calling party (second person) at block 808. In one or more embodiments, the second person can be the person that is initiating the telephone call.

The method 800 continues to block 810, where an incoming call is received. At block 812, a check is made to determine if the incoming call is from a device associated with the calling party. The check can include comparing an incoming telephone number with a contact database stored within the electronic device that is receiving the incoming call. If, at block 812, it is determined that, based on the criteria is received, the incoming call is associated with a custom incoming call announcement, the method 800 continues to block 814, where the audio file including the user-issued salutation is output as the incoming call indication, such as depicted in FIG. 3B. If, at block 812, it is determined that, based on the criteria is received, the incoming call is not associated with a custom incoming call announcement, the method 800 continues to block 816, where the default call announcement is output.

As can now be appreciated, disclosed embodiments provide techniques for creating custom incoming call announcements for individual contacts in a user's contact database. The custom ringtones allow users to identify the caller by sound, without needing to look at any device. Furthermore, the custom incoming call announcements add a personal touch, reflecting the user's relationship or feelings toward that contact. Moreover, disclosed embodiments increase the fun of using an electronic communication device and enable users to express their creativity by selecting or creating unique ringtones that reflect their preferences and the personalities of their contacts.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. A communication device comprising:
at least one output device;
a memory having stored thereon an automatic call announcement (ACA) module; and
at least one processor communicatively coupled to the memory, the at least one processor executing program code of the ACA module, and is configured to cause the communication device to:
obtain audio voice data for a voice conversation from a call between a user of the communication device and a second person;
parse the audio voice data to identify a salutation issued by at least one of the user and the second person in the audio voice data;
generate an audible incoming call announcement to associate with the second person, in part based on the salutation; and
in response to receiving an incoming call originating from a device of the second person, output the audible incoming call announcement in lieu of a default call announcement.

2. The communication device of claim 1, wherein to identify the salutation issued by one of the user and the second person, the at least one processor further is further configured to:
store a history of audio data for multiple voice conversations between the second person and the user; and
determine the salutation based on detecting a phrase in an opening period of a predetermined number of voice calls.

3. The communication device of claim 1, wherein the at least one processor is further configured to:
identify a salutation issued by the user in the audio voice data;
store the salutation as a user-issued salutation audio data sample in the memory;
display a user option to use the user-issued salutation audio data sample as a call announcement for calls originating from a second electronic device associated with the second person; and
in response to receiving an affirmative acknowledgement for the user option, associate the user-issued salutation audio data sample with a contact record corresponding to the second person.

4. The communication device of claim 3, wherein the at least one processor is further configured to:
determine an alias for the second person, in part based on the salutation issued by the user in the audio voice data; and
append the alias to the contact record corresponding to the second person.

5. The communication device of claim 4, wherein further the at least one processor is further configured to render a text representation of the alias on a display of the communication device in response to detecting an incoming call from a second electronic device associated with the second person.

6. The communication device of claim 1, wherein further, the at least one processor is further configured to:
combine the salutation with an audio data sample to create a combined sequential audio sample; and
associate the combined sequential audio sample with a contact record corresponding to the second person.

7. The communication device of claim 1, wherein further, the at least one processor is further configured to:
mix the salutation with an audio data sample to create a combined audio sample; and
associate the combined audio sample with a contact record corresponding to the second person.

8. A method comprising:
obtaining, by a processor of a communication device, audio voice data for a voice conversation from a call between a user of the communication device and a second person;
parsing the audio voice data to identify a salutation issued by at least one of the user and the second person in the audio voice data;
generating an audible incoming call announcement to associate with the second person, in part based on the salutation; and
in response to receiving an incoming call originating from a device of the second person, outputting the audible incoming call announcement in lieu of a default call announcement.

9. The method of claim 8, further comprising:
storing a history of audio data for multiple voice conversations between the second person and the user; and
determining the salutation based on detecting a phrase in an opening period of a predetermined number of voice calls.

10. The method of claim 8, further comprising:
identifying a salutation issued by the user in the audio voice data;
storing the salutation as a user-issued salutation audio data sample;
displaying a user option to use the user-issued salutation audio data sample as a call announcement for calls originating from a second electronic device associated with the second person; and
in response to receiving an affirmative acknowledgement for the user option, associating the user-issued salutation audio data sample with a contact record corresponding to the second person.

11. The method of claim 10, further comprising:
determining an alias for the second person, in part based on the salutation issued by the user in the audio voice data; and
appending the alias to the contact record corresponding to the second person.

12. The method of claim 11, further comprising rendering a text representation of the alias on a display of the communication device in response to detecting an incoming call from a second electronic device associated with the second person.

13. The method of claim 8, further comprising:
combining the salutation with an audio data sample to create a combined sequential audio sample; and
associating the combined sequential audio sample with a contact record corresponding to the second person.

14. The method of claim 8, further comprising:
mixing the salutation with an audio data sample to create a combined audio sample; and
associating the combined audio sample with a contact record corresponding to the second person.

15. A computer program product comprising a non-transitory computer readable medium having program instructions that when executed by a processor of a communication device, configure the communication device to perform functions comprising:
obtaining audio voice data for a voice conversation from a call between a user of the communication device and a second person;
parsing the audio voice data to identify a salutation issued by at least one of the user and the second person in the audio voice data;
generating an audible incoming call announcement, in part based on the salutation; and
in response to receiving an incoming call originating from a device of the second person, outputting the audible incoming call announcement in lieu of a default call announcement.

16. The computer program product of claim 15, further comprising program instructions for:
storing a history of audio data for multiple voice conversations between the second person and the user; and
determining the salutation based on detecting a phrase in an opening period of a predetermined number of voice calls.

17. The computer program product of claim 15, further comprising program instructions for:
identifying a salutation issued by the user in the audio voice data;
storing the salutation as a user-issued salutation audio data sample;
displaying a user option to use the user-issued salutation audio data sample as a call announcement for calls originating from a second electronic device associated with the second person; and
in response to receiving an affirmative acknowledgement for the user option, associating the user-issued salutation audio data sample with a contact record corresponding to the second person.

18. The computer program product of claim 17, further comprising program instructions for:
determining an alias for the second person, in part based on the salutation issued by the user in the audio voice data; and
appending the alias to the contact record corresponding to the second person.

19. The computer program product of claim 18, further comprising program instructions for rendering a text representation of the alias on a display of the communication device in response to detecting an incoming call from a second electronic device associated with the second person.

20. The computer program product of claim 15, further comprising program instructions for:
mixing the salutation with an audio data sample to create a combined audio sample; and
associating the combined audio sample with a contact record corresponding to the second person.
